(19) United States
(12) Patent Application Publication
(10) Pub. No.: US 2004/0170415 A1
(43) Pub. Date: Sep. 2, 2004

(54) Photograph print selling method, photograph print selling program, recording medium on which photograph print selling program is recorded, photograph print selling machine, print medium, and print medium unit

(76) Inventors: Tadasu Maeda, Kyoto-shi (JP); Masamichi Akima, Kyoto-shi (JP); Shigeru Okuno, Kyoto-shi (JP); Hyoue Tamura, Kyoto-shi (JP)

Correspondence Address: Thomas J D'Amico, Dickstein Shapiro Morin & Oshinsky, 2101 L Street NW, Washington, DC, 20037-1526, US

(21) Appl. No.: 10/478,637

(22) PCT Filed: Jun. 7, 2002
(86) PCT No.: PCT/JP02/05674

(30) Foreign Application Priority Data
Jun. 8, 2001 (JP) 2001-173442
Oct. 10, 2001 (JP) 2001-312351

(51) Int. Cl. G03B 15/00

(52) U.S. Cl. 396/2

(57) ABSTRACT

In a photoprint sales method or machine including image capturing means for capturing an image of at least one photographic subject, display means for displaying the image having been captured, editing means for letting the image be edited, and printing means for printing, as a photoprint, copies of the image having been edited and/or the image having been captured, areas dividing the photoprint are provided for allocating the copies thereto. With this, a photoprint corresponding to the users' preferences can be produced even if a plurality of users carry out the shooting together, and these users can cut the photoprint using scissors and the like and suitably distribute the same, without puzzling out how the photoprint should be cut.

### TECHNICAL FIELD

The present invention principally relates to (i) a method, machine, and program of photoprint sales, by which an image is captured by a camera such as, for instance, a digital camera in amusement facilities such as game arcades, and the image having been captured is printed on a sticker sheet using a printer, (ii) a printing medium produced as a result of (i), and (iii) a printing medium unit.

### BACKGROUND ART

In a conventional photo sticker vending machine, an image of a photographic subject is captured, a plurality of copies of the image are produced and tiled in an arbitrary order, and the tiled images are printed on a sticker sheet using a printer so that a photo sticker is produced. Examples of the order of tiling images are such as uniformly laying out 16 images being identical sizes, and laying out images having different sizes in a mixed manner.

When, for instance, two users carry out the shooting using the above-mentioned photo sticker vending machine, the users typically cut the produced photo sticker with scissors and take the images of one's choice.

It is noted that, on the photo sticker printed using the photo sticker vending machine, print images are laid out in accordance with the sizes thereof. For this reason, when, for instance, a photo sticker on which print images having different sizes are laid out in a mixed manner is produced, the users often have to puzzle out how the photo sticker should be cut with scissors and shared.

Further, for instance, the following case has typically occurred: When, using the above-mentioned photo vending machine, two users twice carry out the shooting together, one user chooses a photo sticker on which an image taken in the first shooting is larger in size, while the other user chooses a photo sticker on which an image taken in the second shooting is larger in size. However, conventional sticker vending machines cannot change the layout of photoprint images to be suitable for the users' preferences.

The present invention is done to solve the above-described problem. The objective of the present invention is to provide a photoprint sales method, a photoprint sales machine, and a photoprint, with which a photoprint on which images are laid out in conformity to the preferences of the users being photographed together, and the users can evenly share pieces of the photoprint being cut with scissors.

### DISCLOSURE OF INVENTION

To solve the above-identified problem, a photoprint sales method and machine of the present invention is a photoprint sales method comprising the steps of: capturing an image of at least one photographic subject by image capturing means; displaying the image having been captured; letting editing means edit the image having been captured; and selling a photoprint carrying one or more copies of the image having been edited and/or the image having been captured, printed by printing means, the photoprint sales method being characterized by allowing the user to determine the number of areas on the photoprint, and allocating said more than one copies for each of these areas.

The image capturing means may be a digital camera or a digital video camera. The printing means may be a monotone printer, sepia-tone printer, or color printer.

With the arrangement above, the user can obtain a resultant image on which copies of the captured image are provided in the areas which enables the user to easily divide the resultant image, and thus the user does not have not to worry about how the photoprint should be divided.

The photoprint sales method of the present invention is a photoprint sales method by which a print image on which more than one copies of an image of at least one photographic subject captured by image capturing means are provided is produced, the print image is outputted on a printing medium by printing means, and the printing medium is sold as a photoprint, the photoprint sales method being characterized by comprising the steps of: dividing the print image into one or more areas, in accordance with the number of divisions instructed by the user; and determining layout of at least one of said more than one copies in each of said one or more areas. Further, the photoprint sales machine of the present invention implements the above-described photoprint sales method.

According to the method and arrangement above, the print image is divided into one or more areas, in accordance with the number of divisions determined by the user. Here, it is assumed that in each of the areas one or more images are provided. On this account, the following can be easily carried out: When a plurality of users carry out the shooting together, the number of divisions is determined in accordance with the number of the users, so that the users can cut the produced photoprint into areas using scissors and the like, and each of the users receives the area of his/her choice. Thus, since the users do not have to puzzle out how the photoprint should be divided and distributed, the improvement of customer satisfaction can be expected.

The printing medium of the present invention is to be printed or has been printed by the printing means, in accordance with either the above-described photoprint sales method or photoprint sales machine. With this, it is possible to provide the photoprint which can be easily divided by the users.

For a fuller understanding of the nature and advantages of the invention, reference should be made to the ensuing detailed description taken in conjunction with the accompanying drawings.

### BRIEF DESCRIPTION OF DRAWINGS

FIG. 1 is an oblique perspective view, showing an exterior appearance of a photoprint machine in accordance with an embodiment of the present invention.

FIG. 2 is a functional block diagram of the photoprint machine.

FIG. 3 is a flowchart, showing the steps of shooting, editing, layout determination, and printing.

FIG. 4 is a flowchart, showing the step of layout determination.

FIG. 5 shows an example of a division number determination screen and an example of a layout determination screen.

FIG. 6 shows another example of the layout determination screen and a further example of the layout determination screen.

FIG. 7 shows a further example of the division number determination screen.

FIG. 8 illustrates an example of an image layout determination screen and an example of a printed photo sticker sheet.

FIG. 9 illustrates another example of the image layout determination screen, an example of a layout displayed on a print image display section 35, and another example of the photo sticker sheet.

### BEST MODE FOR CARRYING OUT THE INVENTION

One embodiment of the present invention is described below with reference to the attached drawings.

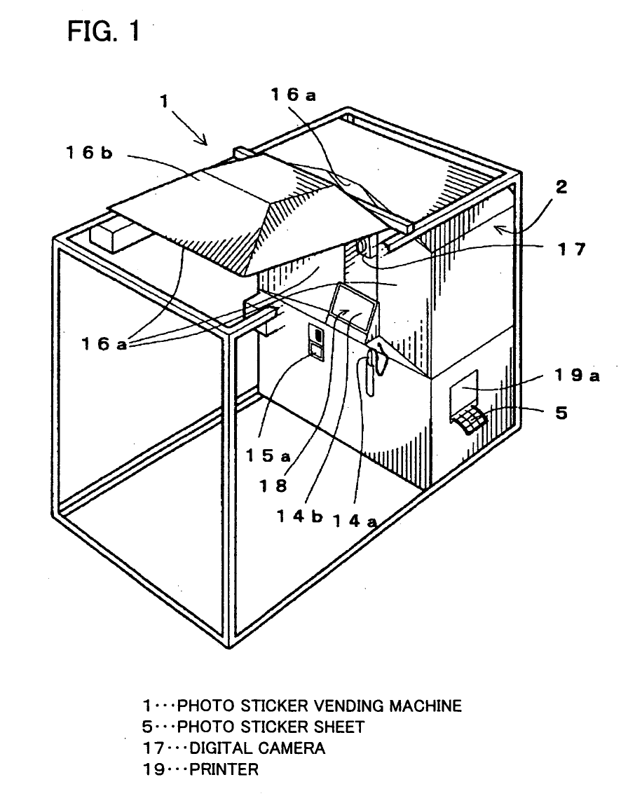

FIG. 1 is an oblique perspective view, showing an exterior appearance of a photoprint machine 1 in accordance with an embodiment of the present invention. Hereinafter, the photoprint machine 1 will be described with reference to this figure.

The photoprint machine 1 has a box-shaped frame, and a housing 2 is provided around one side of the box-shaped frame. The box-shaped frame and the housing 2 form a space, and this space is a user space where the below-mentioned shooting and editing steps are carried out by the users. Hereinafter, a side of the housing 2, which faces the user space, is termed a front face of the housing 2.

On the upper-central part of the front face of the housing 2, a digital camera 17 is provided. The basic shooting direction of this digital camera 17 is slightly descending with respect to the direction normal to the front face, and the shooting direction can be changed in the vertical directions.

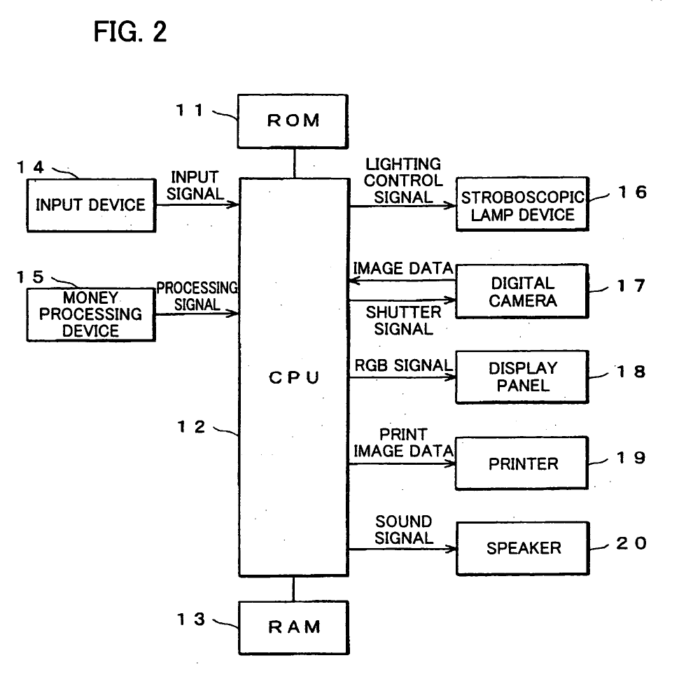

Further on the front face of the housing 2, three scattering plates 16a, each being made up of members such as a translucent member, are provided to the left of, to the right of, and above the digital camera 17, respectively. Behind each of the scattering plates 16a, a stroboscopic lamp device 16 (cf. FIG. 2; not illustrated in FIG. 1) is provided. The light emitted from the stroboscopic lamp device 16 passes through the scattering plate 16a so that the unevenness of the light is eliminated, and then the light is applied to a photographic subject in the user space.

The scattering plates 16a provided to the right and left of the digital camera 17 slightly inclines with respect to the front face, toward the inside of the housing 2. The scattering plate 16a provided above the digital camera 17 slightly inclines downward with respect to the front face. Providing the scattering plates 16a in this manner allows the light passing through the scattering plates 16a to head to the photographic subject.

At the center of the front face of the housing 2, a display panel 18 for displaying images is provided. This display panel 18 also displays a screen for asking the user to determine the number of divisions and the type of layout of decoration images (will be described later).

On the surface of the display panel 18, a touch panel 14b and a touch pen 14a for carrying out touch-type input through the touch panel 14a are provided. The touch panel 14a and touch pen 14b constitute an input device 14 which will be described below. The input device 14 is used for carrying out the step of determining how a sticker sheet is divided into areas and the step of determining how images are allocated to the areas. These steps will be specifically described later.

On the lower part of the front face of the housing 2, an inserting slot 15a for inserting money (e.g. coins) therethrough is provided. On the right side of the housing 2, a photo sticker sheet discharging slot 19a through which a printed photo sticker sheet 5 is discharged is provided.

On the top of the frame of the photoprint machine 1, the scattering plate 16a, a reflecting plate 16b, and the stroboscopic lamp 16 which is not shown in FIG. 1 are provided. The reflecting plate 16b is shaped like a square when viewed in the direction to the front face with respect to the user space, i.e. when viewed from below, and shaped like a trapezoid in profile. That is to say, the reflecting plate 16b is made up of four reflecting surfaces, and these reflecting surfaces incline toward the direction to the front face with respect to the user space. In the back of the central part of the reflecting plate 16b, the stroboscopic lamp device 16 is provided, and in a part of the reflecting plate 16b where the light emitted from the stroboscopic lamp device 16 and light reflected on the reflecting plate 16b pass through, the scattering plate 16a is provided. With this arrangement, uniform light emitted from the scattering plate 16a irradiates the user(s) in the user space from above.

With the arrangement above, the photoprint machine 1 carries out the following process: An image of the photographic subject captured by the digital camera 17 is processed and laid out in a plurality of areas, the number of the areas being determined using the input device 14, and a photo sticker sheet 5 on which images are printed in conformity with the layout is discharged through the photo sticker sheet discharging slot 19a.

Next, a functional design of the photoprint machine 1 will be described with reference to a block diagram of FIG. 2.

In the photoprint machine 1, a control section which controls various operations is provided inside the housing 2 in FIG. 1. This control section is made up of a CPU 12, ROM (Read Only Memory) 11, RAM (Random Access Memory) 13 and the like. The CPU 12 reads programs stored in the ROM 11 out to the RAM 13 which is a work memory, and controls various operations by executing the programs. In the present embodiment, the control section also controls the step of determining how many areas for the division by scissors should be provided on a photo sticker sheet 5 and the step of determining the layout of images in the respective areas.

It is noted that the control section may be made up of PC-based (Personal-Computer-based) devices. In this case, the control section includes a hard disk drive as a large capacity storage and a removable drive such as a CD-ROM drive, in addition to the above-mentioned CPU 12, RAM 13, and ROM 11. The ROM 11 in this case stores, for instance, a BIOS (Basic Input Output System) program for the start-up of the PC, and the control program for controlling various operations of the photoprint machine 1 is stored in the hard disk drive. The control of the various operations is carried out by reading out the control program from the hard disk drive to the RAM 13, and executing the control program by the CPU 12.

Alternatively, the control program may be stored in a removable medium such as a CD-ROM, read out by the removable media drive and then executed, or the control program may be stored in a removable medium and installed in the hard disk and then executed.

When the PC constituting the control section has a communication interface which allows the PC to communicate with an external computer via a communication network, the control program may be downloaded from the external computer via the communication network and then immediately executed, or may be downloaded from the external computer via the communication network, installed in the hard disk drive, and then executed.

The control program includes an image editor program for laying out decoration images as a result of decoration editing (captured images when the decoration editing is not carried out) in the respective areas, the number of areas being determined using the input device 14. Note that, although the control of various operations is carried out in such a manner that the control program having been read out to the RAM 13 is processed by the CPU 12, it is regarded in the following description that the CPU 12 actively carries out the control of various operations, for the sake of simplicity.

The input device 14 is, as described above, made up of the touch panel 14b and touch pen 14a both provided on the display panel 18. An input signal corresponding to the data entered by the user using the touch pen 14a is transmitted from the input device 14 to the CPU 12 having been carrying out the operations. The input signal includes a determination signal concerning the determination of the number of areas provided as a result of the division of the photo sticker sheet 5, and a decoration signal for the decoration editing.

A money processing device 15 is provided behind the inserting slot 15a, and determines whether the money (e.g. coins) inserted through the inserting slot 15a is true or false, and which type the inserted money is. The information regarding the accounting step carried out by the money processing device 15 is transmitted to the CPU 12 having been carrying out the operations.

The stroboscopic lamp devices 16 are lighting devices provided behind the respective scattering plates 16a. Each of the stroboscopic lamp devices 16 flashes in accordance with a lighting control signal outputted as a result of the operations of the CPU 12.

The digital camera 17 receives a shutter signal outputted as a result of the operations of the CPU 12, and transmits image data such as moving image data and still image data to the CPU 12 having been carrying out the operations.

The display panel 18 receives an RGB signal outputted as a result of the operations of the CPU 12, and displays an image in accordance with this RGB signal. The display panel 18 is, for instance, a flat screen such as a CRT (Cathode Ray Tube) and liquid crystal display device.

The printer 19 receives print image data outputted as a result of the operations of the CPU 12, and prints a print image on a photo sticker sheet 5 and discharging the same. As the printer 19, for instance, a dye sublimation printer is suitably adopted. However, not limited to this, any printers which can produce a photo image with a certain level of quality can be adopted.

The speaker 20 receives a sound signal outputted as a result of the operations of the CPU 12, and produces a sound in accordance with the signal. The types of the sound are such as an operation guide for the user, BGM, and sound effects.

With the above-described arrangement, the photoprint machine 1 carries out the following steps of: image editing for laying out decoration images as a result of decoration editing (captured images when the decoration editing is not carried out) in the areas, the number of areas being determined using the input device 14; printing carried out by the printer 19, according to the print image data generated in accordance with the image data with the layout, and discharging the photo sticker sheet 5 on which the printing is completed.

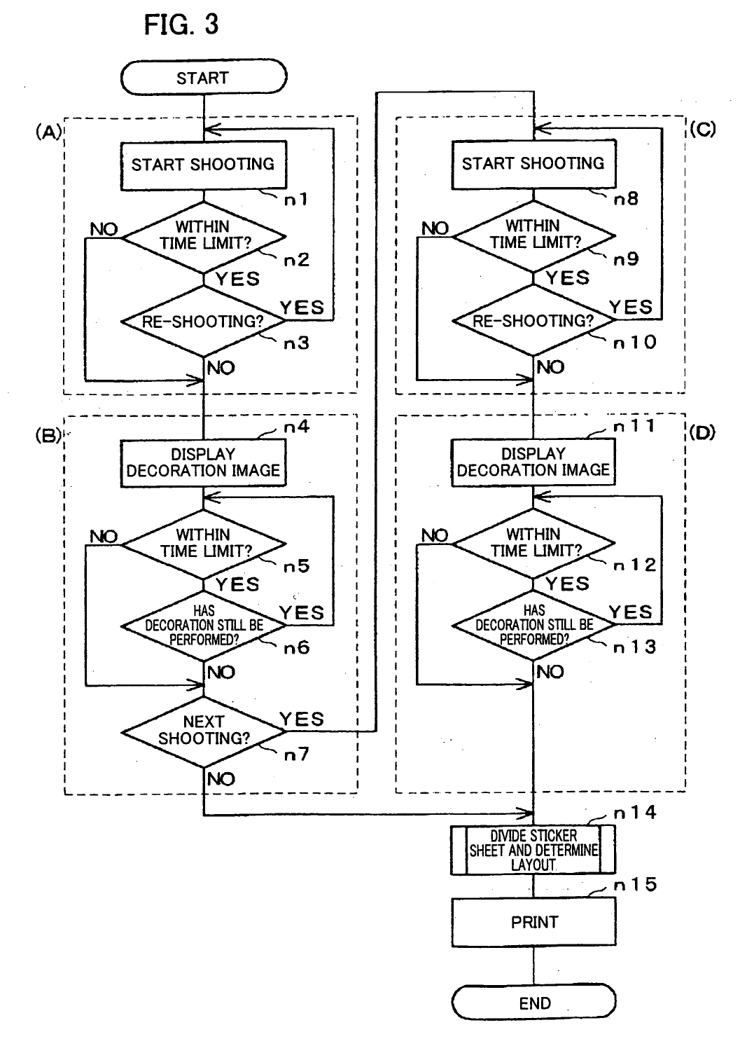

Now, referring to a flowchart of FIG. 3, the following will describe a flow of the steps carried out in the photoprint machine 1.

After entering into the user space of the photoprint machine 1, the user inserts money (e.g. coins) into the inserting slot 15a (cf. FIG. 1) as payment, in accordance with, for instance, the operation guide displayed on the display panel 18. On the insertion of the money, the money processing device 15 (cf. FIG. 2) determines whether the inserted money is true or false and which type the inserted money is, and transmits an accounting completion signal to the CPU 12. After the CPU 12 receives this accounting completion signal, the steps below are carried out. Note that, in the present embodiment, it is assumed that users A and B carry out the shooting together, and operations which can be carried out either one of the users A and B are described as the operations carried out by “the user”.

Following the steps described above, the CPU 12 causes the display panel 18 to display a moving image being captured by the digital camera 17. Simultaneously, the CPU 12 causes the display panel 18 to display a shooting start button. When the user touches the shooting start button on the touch panel 14b using the touch pen 14a, the step of shooting starts (Step n1).

When the user touches the shooting start button by the touch pen 14a, the CPU 12 transmits the sound signal to the speaker 20, and the speaker 20 starts to produce a voice countdown. On the completion of the countdown, the CPU 12 instructs the stroboscopic lamp device 16 to flash, and simultaneously instructs the digital camera 17 to capture a still image.

During the execution of the above-mentioned steps, the CPU 12 measures a period of time elapsed since the completion of the accounting step. If the elapsed time exceeds a predetermined time limit (e.g. 60 seconds), the process compellingly goes to below-mentioned Step n4 (Step n2). In this instance, the following operations may be carried out: If the users have already completed the shooting at least once, the captured image is adopted as an image to be printed, and if the users have never completed the shooting, the shooting is compellingly carried out and the captured image is adopted as an image to be printed.

Note that, the CPU 12 causes the display panel 18 to display count down clocks of the above-mentioned time limit, until the image to be printed is determined.

If, after completing the first shooting, the elapsed time is still shorter than the time limit, the CPU 12 causes the display panel 12 to display a still picture of the captured image, and also displays a “keep” button and re-shooting button. If the user touches the re-shooting button, the process goes back to Step n1. If the user touches the “keep” button, the CPU 12 subtracts, from the time limit, the time elapsed (e.g. 40 seconds) in the phase A from Step n1 to Step n3, and causes the RAM 13 to record the remaining time (20 seconds in this case) having been figured out. Then the process goes to the next step (Step n3).

The CPU 12 transmits the RGB signal to the display panel 18 so as to cause the display panel 18 to display the captured image as an image to be decorated (hereinafter, this image will be referred to as a decoration image), and adds the remaining time (20 seconds in this case) of the phase A, the time having been recorded in the RAM 13, to the time limit (e.g. 60 seconds) of a phase B which will be carried out from now forward, so that the time limit is increased (to, in this case, 80 seconds) (Step n4). Simultaneously, the CPU 12 causes the display panel 18 to display a next shooting button and printing button.

Subsequently, the user carries out the decoration step which is an editing process with respect to the decoration image using the touch pen 14a.

The CPU 12 measures the time elapsed in the phase B, and if this elapsed time is shorter than the time limit (80 seconds in this case) which has been lengthened as above, the process goes to the next step, and if the elapsed time excesses the time limit, the process compellingly goes to Step n7 (Step n5).

The CPU 12 determines whether or not the users are still in the middle of the decoration, and if so, the process goes back to Step n5. If the decoration has been completed, the process goes to the next step (Step n6).

If the user touches the printing button by the touch pen 14a, the process proceeds to Step n14. If the user touches the next shooting button by the touch pen 14a, the CPU 12 subtracts, from the time limit (80 seconds in this case), the time (e.g. 50 seconds) elapsed in the phase B from Step n4 to Step n7, and causes the RAM 13 to record the remaining time (30 seconds in this case) having been figured out. Then the process goes to the next step (Step n7).

Note that, until the next shooting button is touched, the CPU 12 causes the display panel 18 to display count down clocks of the time limit (80 seconds in this case) in the phase B.

The next phase C is made up of three steps, namely, Steps n8 to n10, and in this phase C, the shooting is carried out in a manner similar to the shooting in the phase A. Note that, however, in Step n8 which is the first step in the phase C, the CPU 12 adds the remaining time (30 seconds in this case) of the phase B to the time limit (60 seconds), so as to increase the time limit (to 90 seconds) (Steps n8-n10).

The next phase D includes three steps, namely, Steps n11 and n12, and in this phase D, the operations identical with those in Steps n4-n6 in the phase B are carried out. Provided that 40 seconds have passed in the phase C, remaining 50 seconds are added to the time limit (e.g. 60 seconds) of the phase D, and thus the users are allowed to carry out the decoration for 110 seconds (Steps n11-n13).

Note that, when the decoration is carried out in the phase D, the CPU 12 gives instructions to display the decoration image in the phase B and the decoration image in the phase D as scale-down thumbnail pictures, and allows the user to select one of the decoration images using the touch pen 14a. With this arrangement, the user can continue the decoration having been carried out in the phase A, when time permits in the phase D.

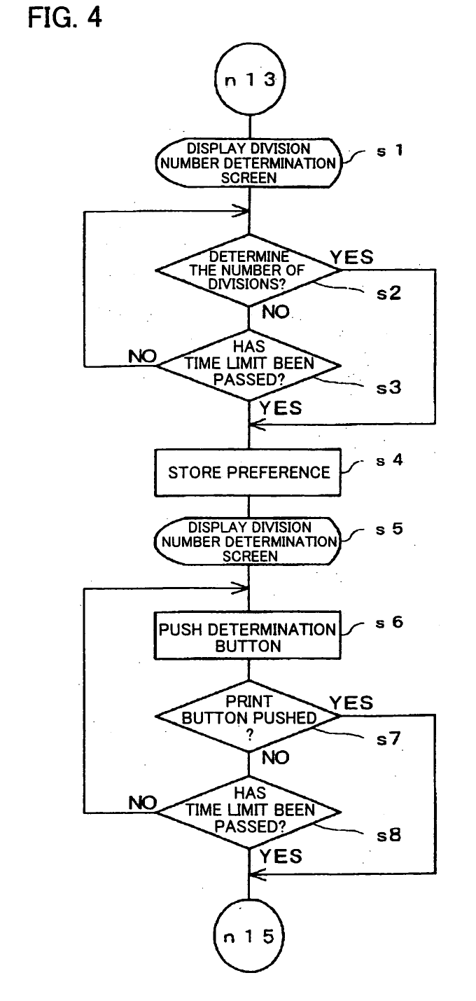

In the next step, the CPU 12 causes the display panel 18 to display a screen for determining the number of divisions on the sticker sheet and for determining the layout (Step n14). Now, with reference to a flowchart of FIG. 4, the steps of determining the number of divisions and the layout will be specifically described below.

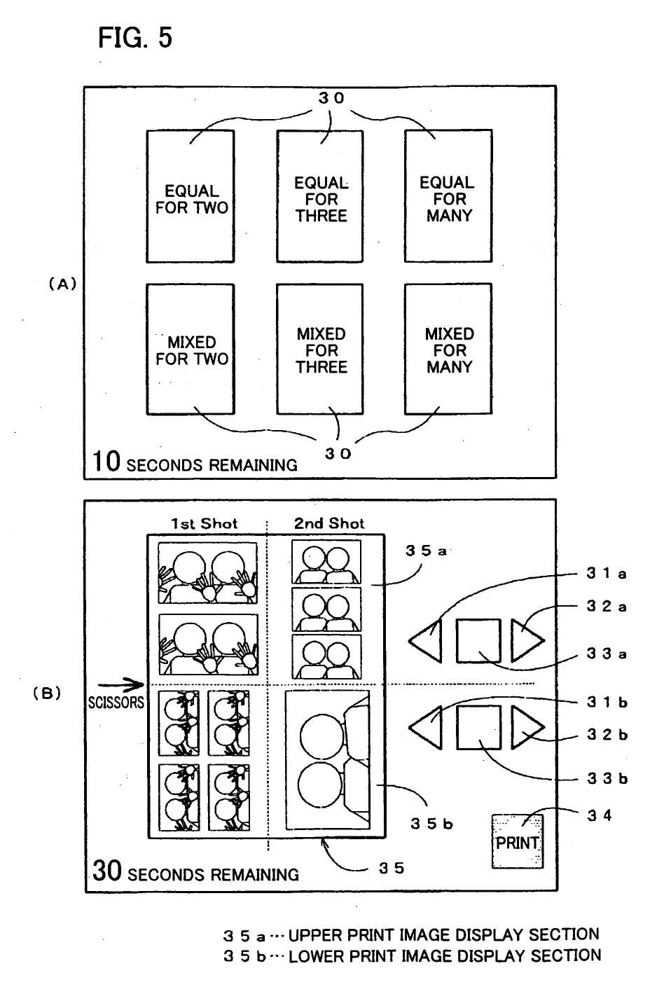

First, the CPU 12 causes the display panel 18 to display a division number determination screen which is shown as an illustration (A) in FIG. 5 (Step s1). This division number determination screen displays six division number determination buttons 30 to which the following choices are allocated for selection: Equal for Two, Mixed for Two, Equal for Three, Mixed for Three, Equal for Many, and Mixed for Many. The user touches any one of the division number determination buttons 30 (e.g. Mixed for Two) using the touch pen 14a, within the time limit of, for example, 10 seconds (Step s2). If none of the division number determination buttons 30 is touched within the time limit, one of the buttons, e.g. Mixed for Two, is compulsorily selected and the process goes to the next step (Step s3).

Note that, among the division number determination buttons 30, three “Mixed” buttons are selected when a sheet on which decoration images having different sizes are laid out is produced, whereas three “Equal” buttons are selected when a sheet on which decoration images are equally laid out is produced.

The CPU 12 receives an input signal corresponding to the input from the user, and causes the RAM 13 to store the preference indicated by the input signal (Step s4), then the CPU 12 causes the display panel 18 to display a layout determination screen shown as an illustration (B) in the figure (Step s5). The layout determination screen shows a print image display section 35, and in this section 35 a horizontal dotted line is drawn as a border line between an upper print image display section 35a and lower print image display section 35b, in conformity with the above-mentioned determination of the number of areas (in this case, the section 35 is divided in two for two persons). In other words, the print image display section 35 is divided in the middle into an upper part and lower part, by the horizontal dotted line.

On the right side of the print image display section 35, a horizontal dotted line as an extension of the above-described horizontal dotted line is drawn so as to divide the right side into an upper part and lower part, and this side being divided in two is termed a layout determination section. This layout determination section includes a Forward button 32a, a Backward button 31a, and a Back to Start button 33a which are displayed on the part above the horizontal dotted line and are provided for determining the layout of the decoration images in the print image display section 35a. The layout determination section also includes a Forward button 32b, a Backward button 31b, and a Back to Start button 33b which are displayed on the part below the horizontal dotted line and provided for determining the layout of the decoration images in the print image display section 35b. Note that, a vertical dotted line which divides the print image display section 35 into a right and left parts is an additional line for displaying a decoration image captured in the first shooting on the left part and a decoration image captured in the second shooting on the right part.

The user A accordingly touches the Forward button 32a, Backward button 31a, and Back to Start button 33a, so as to select the most favorable layout of the decoration images in the upper print image display section 35a, in the most favorable layout the number and sizes of the decoration images meeting the preference of the user A. The user B also accordingly touches the Forward button 32b, Backward button 31b, and Back to Start button 33b, so as to select the most favorable layout of the decoration images in the lower print image display section 35b, in the most favorable layout the number and sizes of the decoration images meeting the preference of the user B (Step s6).

When the users finish the above-mentioned selections within the time limit of, for instance, 30 seconds and one of the users touches a Printing button 34, the process goes to the next step, i.e. Step n15 as shown in FIG. 3 (Step s7). Even if the Printing button 34 has not been touched, the process compellingly goes to Step n15 shown in FIG. 3, if the elapsed time exceeds the time limit (Step s8).

When the subroutine (corresponding to Steps s1-s8) of Step n14, which is the layout determination process, has finished, the CPU 12 causes the printer 19 to print a photo sticker sheet 5 on which decoration images are laid out in accordance with the number of divisions and the layout which have been determined, and discharge the sheet 5 through the photo sticker sheet discharging slot 19a (Step s15). The photo sticker sheet 5 having been discharged is divided into an upper part and lower part by, for instance, scissors, and consequently, the users A and B can obtain respective photo stickers on which a wished number of decoration images having wished sizes are printed.

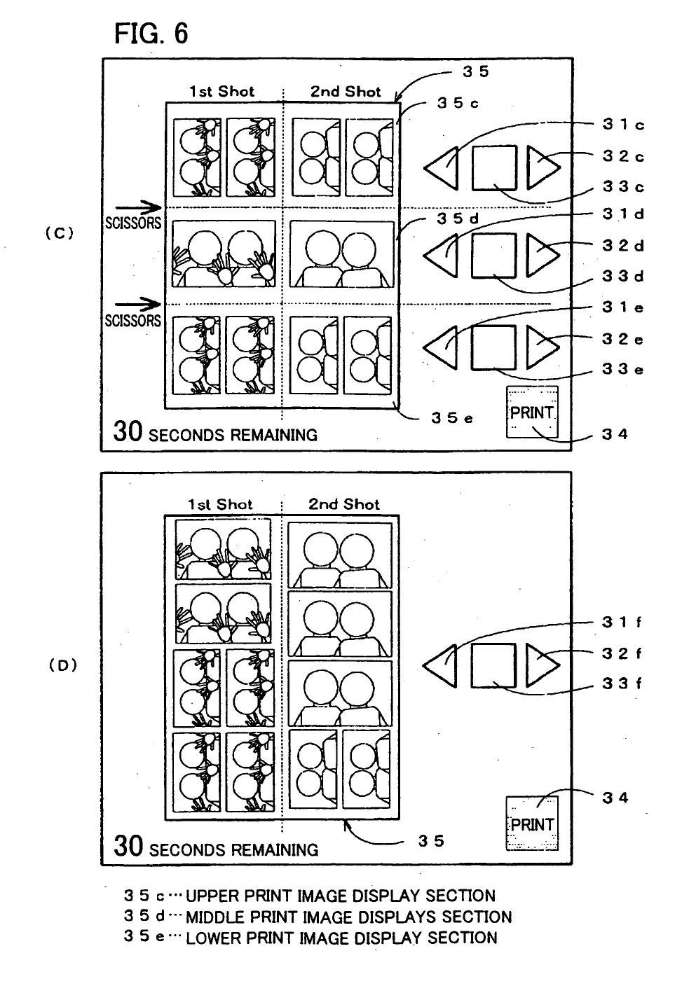

Note that, if, for instance, “Equal for Three” is selected by pushing the corresponding division number determination button 30 in Step s2 of the above-mentioned subroutine, a layout determination screen shown as an illustration (C) in FIG. 6 is displayed in Step s5. Since a photo sticker sheet in this case is for three persons, the print image display section 35 is equally divided into an upper print image display section 35c, a middle print image displays section 35d, and a lower print image display section 35e. Further, on the right side of the screen, a Forward button 32c, a Backward button 31c, and a Back to Start button 33c are provided in the upper section, a Forward button 32d, a Backward button 31d, and a Back to Start button 33d are provided in the middle section, and a Forward button 32e, a Backward button 31e, and a Back to Start button 33e are provided in the lower section. Selecting this layout and carrying out the printing, the user can obtain a photo sticker sheet 5 which can be easily divided into three parts by, for instance, scissors.

If, for instance, “Mixed for Many” is selected by pushing the division number determination button 30 in Step s2 of the above-mentioned subroutine, a layout determination screen shown as an illustration (D) in FIG. 6 is displayed in Step s5. In this case, the horizontal dotted line is not drawn so that only the vertical dotted line is drawn, and the overall layout is determined using a Forward button 32f, a Backward button 31f, and a Back to Start button 33f which are displayed on the right side of the print image display section 35. After demarcating decoration images as a result of the first shooting and decoration images as a result of the second shooting by drawing the vertical dotted line, the users determine how these decoration images are distributed among them.

As a result of the above-described arrangements, structures, and operations, the users can obtain a photo sticker sheet 5 on which decoration images which are generated by performing the decoration editing to captured images (or captured images when the decoration is not carried out) are laid out in an easily dividable manner.

Note that, it is possible to adopt such an arrangement that, the vertical dotted line of the above-described embodiment, which is shown in the illustrations (B) in FIG. 5, (C) in FIG. 6, or (D) in FIG. 6, is omitted, and in the case of, for instance, the illustration (B) in FIG. 5, the upper print image display section 35a and lower print image display section 35b are not divided by the vertical dotted line, and only decoration images of the first shooting are provided in the upper print image display section 35a, while decoration images of the first and second shootings are provided in the lower print image display section 35b. This arrangement allows the users to determine the layout of decoration images more freely.

It is also possible to adopt such an arrangement that, for instance, the Forward button 32b, Backward button 31b, and Back to Start button 33b in the illustration (B) in FIG. 5 are not displayed, and an image to be printed, on which a horizontal dotted line is drawn and decoration images are laid out, is displayed on the print image display section 35 by operating the Forward button 32a, Backward button 31a, and Back to Start button 33a. With this arrangement, it is possible to obtain a photo sticker sheet 5 which can be easily divided using scissors and the like, by means of a simple interface.

The above-mentioned print image display section 35 is divided into the upper and lower parts, along the horizontal dotted line. However, the print image display section 35 may be divided in any direction, e.g. horizontally.

The followings are alternative embodiments of the determination of the number of divisions described with reference to the illustration (A) in FIG. 5 and the layout of the decoration images on the print display section 35 described with reference to the illustrations (C) and (D) in FIG. 6.

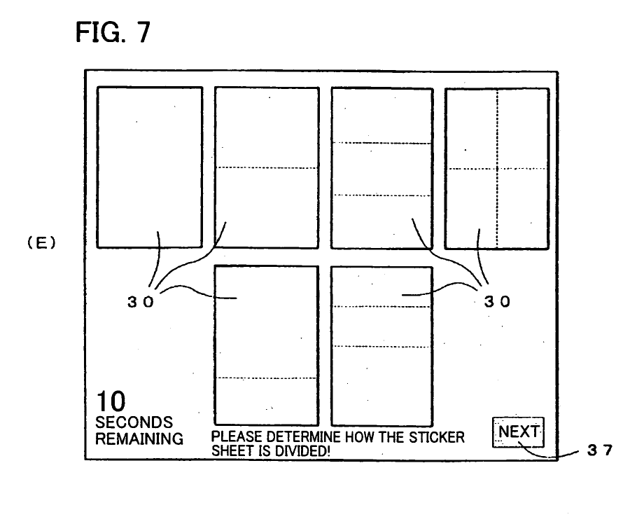

Second Embodiment relates to a method of displaying the division number determination screen described in the embodiment above (hereinafter, First Embodiment) with reference to the illustration (A) in FIG. 5, in the manner shown in FIG. 7.

That is, as an illustration (E) in FIG. 7 shows, the division number determination screen may be arranged such that images of sticker sheets on which division lines are drawn are displayed as division number determination buttons 30, allowing the user to determine how a sticker sheet is divided, using these division number determination buttons 30.

After determining the divisions by the division number determination buttons 30, the layout determination screen (illustration (B) in FIG. 5) is then displayed when the user touches a Next button 37. There is an alternative arrangement such that the Next button 37 is not provided so that the layout determination screen is displayed when one of the division number determination buttons 30 is touched.

The present embodiment allows the user to visually grasp the divisions, even if the divisions are not evenly done. Thus, the user can clearly grasp how the sticker sheet is divided in a look-and-feel manner, and hence the division can be performed more flexibly.

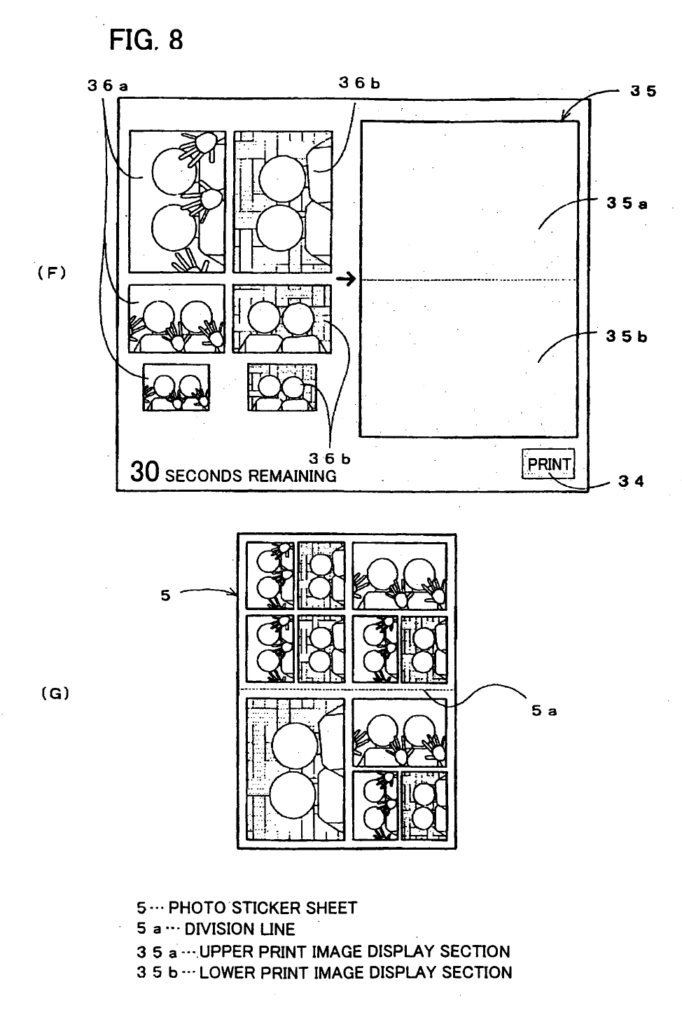

Third Embodiment relates to a method of determining the layout of the decoration images on the print image display section 35, the determination having been described in First Embodiment with reference to the illustrations (B) in FIG. 5 and (C) and (D) in FIG. 6, by means of drag-and-drop technique shown in FIG. 8. That is, as shown in an illustration (F) in the figure, the user selects any one of decoration images 36a and 36b using the touch pen 14a, and then the user touches either one of an upper print image display section 35a and lower print image display section 35b, so that the decoration images 36 (36a and 36b ) having different sizes can be freely laid out in the upper and lower print image display sections 35a and 35b.

An illustration (G) in FIG. 8 shows an example of a photo sticker sheet 5 arranged and printed in accordance with the above-described method. On this photo sticker sheet 5, a dotted division line 5a is provided along with the decoration images 36, in order to indicate how the photo sticker sheet 5 should be divided using scissors and the like.

The present embodiment allows the user to arbitrarily layout the decoration images 36 in accordance with their preferences, so that the user's options for the layout can be broadened.

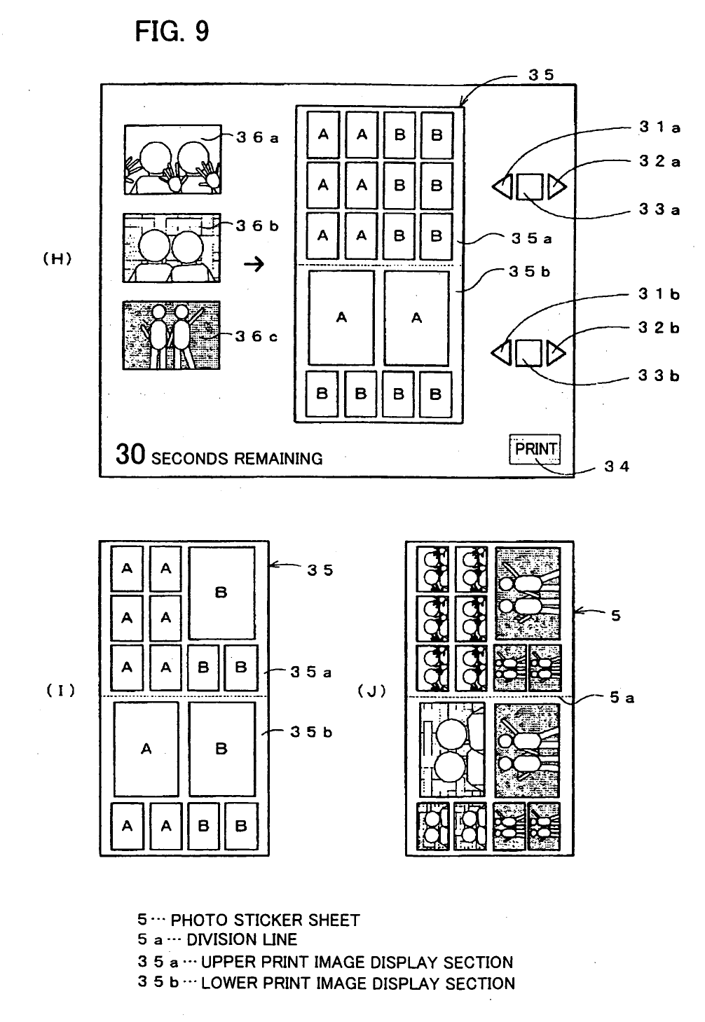

Fourth Embodiment relates to a method of determining the layout of decoration images in such a manner that, as shown in FIG. 9, the layout of decoration images is determined, and then the decoration images to be provided in accordance with the layout are determined.

That is to say, as an illustration (H) in the figure shows, the user selects a layout for providing decoration images, by means of a Forward button 32 (32a, 32b ), a Backward button 31 (31a, 31b ), and a Back to Start button 33 (33a, 33b ). The layout having been selected is displayed on the print image display section 35, and the user touches and selects the decoration images 36 and then touches the print image display section 35, so that the selected decoration images 36 are provided in touched sections (e.g. in all of six sections A when any one of these section A is touched).

An illustration (I) in FIG. 9 shows an example of the layout displayed on the print image display section 35, and, when, for example, a decoration image 36a is provided in a section A in an upper print image display section 35a and a decoration image 36c is provided in a section B in the same section 35a, a photo sticker sheet 5 shown in an illustration (J) in the figure is obtained.

In Second, Third, and Fourth Embodiments, the arrangements, structures, and operations other than the above are identical with those of First Embodiment. Thus, members and sections having the same functions as those described in First Embodiment are given the same numbers, so that the descriptions are omitted for the sake of convenience.

Note that, the following arrangements may be adopted: The division line 5a is drawn with markers such as pictures of scissors and arrows, a blank space where the division line 5a is drawn is arranged so as to be broader than other blank spaces, for accentuating the division line 5a, and a sticker sheet having been perforated is prepared as a mounting of the photo sticker sheet 5.

Also, the determination of the division number carried out in Step S1 shown in FIG. 4 may be carried out after Step n1 and before Step n2 in FIG. 3. In this case, after the determination of the number of divisions, it is possible to allow the user to confirm the number.

Further, the input device 14 may be a touch panel in which the input is carried out by touching the touch panel 14b.

In the foregoing embodiments, it is assumed that the photo sticker sheet 5 is a sticker sheet made up of an adhesive sheet and a removable sheet adhered to the adhesive surface of the adhesive sheet. However, the photo sticker sheet 5 may be a paper sheet which is a typical paper medium.

The following arrangement may be adopted as well: The printer 19 is provided with an ID tag reader/writer, and a print sheet which is a medium to which a photo print is outputted and an ID tag (identification medium) are delivered together as a print paper unit. When the printer 19 is a dye sublimation printer, an ink film for dye sublimation may be added to the unit made up of the print sheet and ID tag.

The ID tag reader/writer reads out various types of identification information recorded in the ID tag, and outputs the same to a control section. The ID tag is made up of members such as an IC chip functioning as a memory. The identification information includes an inherent ID, the number of sheets, the type of papers, and color information inherent in the ink (if the ink film is included in the unit), and so on.

The control section determines, in accordance with the identification information read out by the ID tag reader/writer, whether or not an attached print sheet and ink film can be used in the photoprint machine 1, and if feasible, causes the printer to be operable. In other words, only designated print paper and ink film can be used in the photoprint machine 1.

In accordance with the information which relates to the number of sheets and is recorded in the ID tag, the number of sheets is counted down as each of the print sheets is used, and this makes it possible to grasp how many print sheets remain. Thus, a display means may be provided for raising an alert when the number of remaining sheets is scarce, and this makes it possible to avoid a paper-out condition during use by the user. Note that, when the number of sheets is counted down, the information regarding the number of sheets, which is recorded in the ID tag, is rewritten. With this, the information recorded in the ID tag indicates 0 when running out of the sheets, so that the ID tag is invalidated.

Further, the information regarding the type of sheets and the color information inherent in the ink, which are recorded in the ID tag, are read out, and the color combination of image data is compensated in accordance with these sets of information so that image output is suitably carried out with respect to the sheets and ink films.

There are two types of the ID tag, namely a non-contact ID tag which can carry out wireless data communication and a contact ID tag provided with a terminal, and the ID tag reader/writer supports at least either one of these ID tags.

In the above-described example, whether or not a print sheet is usable is determined using the ID tag. Not limited to this, however, the determination may be carried out using, for instance, a barcode printed on a packing material and the like, in which print papers and ink films are packed. Note that, however, the use of the barcode has such problems as the amount of information to be stored is small and the rewriting of information in accordance with the countdown of the number of sheets cannot be carried out.

As described above, a photoprint sales method and machine of the present invention is a photoprint sales method comprising the steps of: capturing an image of at least one photographic subject by image capturing means; displaying the image having been captured; letting editing means edit the image having been captured; and selling a photoprint carrying one or more copies of the image having been edited and/or the image having been captured, printed by printing means, the photoprint sales method allowing the user to determine the number of areas on the photoprint, and allocating said more than one copies for each of these areas.

As a preferable arrangement, it is possible to let the user determine the number of divisions. With this, it is possible to shorten the time required for determining the layout.

As a preferable embodiment, the areas may be equal-sized. With this, when, for instance, three users carry out the shooting together, the layout of providing three equal-sized areas is selected so that the photo stickers are equally distributed to these users.

In the present invention, it is possible to produce a photo sticker sheet on which the images are to be provided or have been provided in areas as a result of division, by means of the above-mentioned photo sticker automatic selling method or photo sticker automatic selling machine. As a preferable embodiment, the photo sticker sheet may be a photo sticker sheet on which the areas as a result of division have been indicated or are to be indicated by markers.

Examples of the markers include a printed dotted line and picture of scissors, a perforated line on a mounting paper of the photo sticker sheet, and a blank space which is broader than other blank spaces.

This arrangement makes it possible to grasp how the photo sticker sheet should be divided, in a look-and-feel manner.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### Industrial Applicability

As in the foregoing descriptions, the photoprint machine of the present invention enables the user to easily divide the photo sticker using scissors and the like. Furthermore, even when a plurality of users carry out the shooting together, these users do not have to puzzle out how the images printed on the photo sticker are distributed. Since each of the users can arbitrarily determine the layout of images of one's choice in the area allocated to him/her, it is possible to prevent an argument between the users over the number and sizes of images.

As a result of the effects above, the customer satisfaction is improved so that managers of amusement facilities can expect the increase of sales.

1. A photoprint sales method, comprising the steps of:
capturing an image of at least one photographic subject by image capturing means;
displaying the image having been captured;
letting editing means edit the image having been captured; and
selling a photoprint carrying more than one copies of the image having been edited and/or the image having been captured, printed by printing means,
the photoprint sales method allowing the user to determine the number of areas on the photoprint, and allocating said more than one copies for each of these areas.

2. A photoprint sales method by which a print image on which more than one copies of an image of at least one photographic subject captured by image capturing means are provided is produced, the print image is outputted on a printing medium by printing means, and the printing medium is sold as a photoprint,
the photoprint sales method being characterized by comprising the steps of:
dividing the print image into one or more areas, in accordance with the number of divisions instructed by the user; and
determining layout of at least one of said more than one copies in each of said one or more areas.

3. The photoprint sales method as defined in claim 2, further comprising the step of displaying the image having been captured, by display means.

4. The photoprint sales method as defined in either one of claims 2 and 3, further comprising the step of obtaining an edited image produced by subjecting the image having been captured to editing performed by the user, and
said more than one copies provided on the print image being produced from the image having been captured and/or the edited image.

5. The photoprint sales method as defined in any one of claims 1-4, wherein, the type of said one or more copies provided in each of said one or more areas is determined by the user.

6. The photoprint sales method as defined in any one of claims 1-5, wherein, the number of said one or more copies provided in each of said one or more areas is determined by the user.

7. The photoprint sales method as defined in any one of claims 1-7, wherein, the sizes of said one or more copies provided in each of said one or more areas is determined by the user.

8. The photoprint sales method as defined in any one of claims 1-7, wherein, the layout of said one or more copies provided in each of said one or more areas is determined by the user.

9. A photoprint sales program, causing a computer to implement the photoprint sales method defined in any one of claims 1-8.

10. A recording medium, storing a photoprint sales program causing a computer to implement the photoprint sales method defined in any one of claims 1-8.

11. A photoprint sales machine, including:
image capturing means for capturing an image of at least one photographic subject;
display means for displaying the image having been captured;
editing means for letting the image having been captured be edited; and
printing means for printing, as a photoprint, one or more copies of the image having been edited and/or the image having been captured,
the photoprint sales machine being characterized by comprising:
division number determination means for determining, on the photoprint, how many areas are required by the user.

12. The photoprint sales machine as defined in claim 11, further comprising image selection means for selecting the image having been edited and/or the image having been captured for each of the areas.

13. The photoprint sales machine as defined in either one of claims 11 and 12, further comprising image number determination means for determining how many copies of the image having been edited and/or the image having been captured are provided in each of the areas.

14. The photoprint sales machine as defined in any one of claims 11, 12, and 13, further comprising image size determination means for determining the sizes of the copies of the image having been edited and/or the image having been captured, in each of the areas.

15. The photoprint sales machine as defined in any one of claims 11-14, further comprising image layout determination means for determining the layout of the copies of the image having been edited and/or the image having been captured, in each of the areas.

16. A photoprint sales machine, comprising:
image capturing means for capturing an image of at least one photographic subject;
image producing means for producing a print image on which more than one copies of the image having been captured are provided; and
printing means for outputting the print image on a printing medium,
the photoprint sales machine being characterized in that, the image producing means implements the photoprint sales method defined in any one of claims 1-8.

17. A printing medium to be printed or having been printed by the printing means, in accordance with either the photoprint sales method defined in any one of claims 1-8 or the photoprint sales machine defined in any one of claims 11-16.

18. The printing medium as defined in claim 17, wherein, a marker which causes said one or more areas to be identifiable will be printed thereon or has been printed thereon.

19. A printing medium unit, comprising:
a printing medium on which an image is to be printed; and
an identification medium which records identification information regarding the printing medium,
the printing medium unit being characterized in that, the identification information recorded in the identification medium is read out by identification information reading means provided in the photoprint sales machine defined in any one of claims 11-16, and after confirming a content of the identification information, an image is outputted on the printing medium.
